(19) United States
(12) Patent Application Publication
(10) Pub. No.: US 2010/0068331 A1
(43) Pub. Date: Mar. 18, 2010

(54) ELECTRIC HEATING DEVICE FOR HOT RUNNER SYSTEMS

(76) Inventor: Herbert Gunther, Allendorf (DE)

Correspondence Address: CLARK & BRODY, 1090 VERMONT AVENUE, NW, SUITE 250, WASHINGTON, DC, 20005, US

(21) Appl. No.: 12/311,904

(22) PCT Filed: Aug. 24, 2007
(86) PCT No.: PCT/EP2007/007433

§ 371 Date: Apr. 17, 2009

(30) Foreign Application Priority Data
Oct. 18, 2006 (DE) 10 2006 049 669.8

(51) Int. Cl. B29C 45/74; B29C 45/20; H01C 17/00

(52) U.S. Cl. 425/549; 425/547; 29/611

(57) ABSTRACT

The invention relates to an electric heating unit (10; 30) for hot runner systems, in particular hot runner nozzles (12) and/or hot runner manifolds, comprising at least one tubular or muff-like support (20; 32) fitted with at least one heating conductor (22) which is constituted by a resistance wire (23). The invention furthermore relates to a hot runner system fitted with such an electric heating unit, also to a hot runner nozzle.

The present invention relates to an electric heating unit for hot runner systems, in particular hot runner nozzles and/or hot runner manifolds.

Hot runner systems are used in injection molds in order to feed a flowable material such as a plastic melt at a given temperature and under high pressure to a separable mold insert. Such systems typically comprise a material feed pipe fitted with a flow duct, said pipe ending in a nozzle mouth. The nozzle mouth subtends at its end a nozzle discharge aperture terminating through a gate aperture into the mold insert (mold nest). To prevent the flowable material from prematurely cooling within the material feed pipe, one or more electrical heating elements are used to ensure a temperature as uniform as feasible as far as into the nozzle mouth.

The electrical heating unit illustratively may be a separate component with a helicoidal heating element integrated into the tubular casing and circumferentially deposited on said material pipe. As disclosed for instance in the German patent document U 295 07 848 or in the US patent document U.S. Pat. No. 4,558,210, said casing may be a rigid structure affixed in the axial direction by additional retaining or tightening elements on the material pipe. Alternatively the heating unit may be designed in the form of flexible heating strips or as a flexible heating mat between electrically insulating layers, where called for with different thermal conductivities, that are affixed to the outside of the material feed pipe. The European patent document EP B1 0 028 153 uses thermally conducting adhesive strips whereas the document WO 97/03540 uses flexible retention tapes with velcro or snap-in locking means.

One drawback of these known heating units is their substantial bulk, as a result of which much room is required for hot runner nozzle installation; this aspect is undesirable in most cases, especially where small nest spacings are required. Such comparatively large dimensions also entail more heating power with attendant increased energy consumption. Again, the large thermal inertias prolong the heating and cooling phases, thereby limiting high production rates.

The German patent document DE A 199 41 038 proposes to eliminate such problems by depositing on at least one wall of a material feed pipe associated with a flow duct at least one insulating layer and at least one heating layer comprising thermally conducting tracks by direct and integral deposition, in other words, to make the heating unit and the material feed pipe integral. Direct deposition illustratively can be carried out by the techniques of film making, thick layer or screen printing techniques, where, following deposition, the layers each shall be baked, hereafter “fired”, separately or simultaneously. Such an integrated stratified heating unit deposition assures permanent, firm affixation to the flow duct wall and hence to the hot runner manifold or the hot runner nozzle. Because of the small sizes made possible by direct deposition, the heating unit in turn requires only little space, and in this manner, extremely compact design—compared to the previously cited heating units—shall be attained at nearly the same outputs. Such outputs also may be increased because the heat is directly generated on/and dissipated from the surface of hot runner element to be heated. In this manner overheating the generally delicate heating elements is avoided. Moreover, the nozzle may be heated quickly and accurately and be cooled rapidly, allowing improved production runs.

However said heating units incur the drawback that the selection of the heating layer material is restricted to those of such low firing temperatures which will not affect the microstructure of the material feed pipe that typically is made of tool steel and that also is exposed to the firing temperatures while the firing procedure is unchanged. Accordingly the firing temperatures of the heat conducting layers may not exceed the processing temperature of the feed pipe's raw material.

The objective of the present invention is to circumvent the above and other drawbacks of the state of the art and to offer an improved heating unit which can be made in simple and economic manner. In particular the present invention relates to a corresponding manufacturing method, to an improved hot runner system and to an improved hot runner nozzle.

The main features of the present invention are defined by the claims 1, 25, 27, 28, 31 and 32. Embodiment modes are the objects of claims 2 through 24, 26, 29 through 30 and 33 through 40.

An electric heating unit for hot runner systems, in particular for hot runner nozzles and/or hot runner manifolds and defined by the present invention comprises at least one tubular or muff-like support bearing at least one heating conductor constituted by a(n electric) resistance wire.

Due to the tubular or muff-like design of the said support, all of the heating unit can be slipped onto a material feed pipe of a hot runner nozzle, resulting in a design in two parts, namely the heating unit and the material feed pipe. The heating unit is commensurately exchangeable. Alternatively the heating unit also may be constituted directly on the material feed pipe or on a manifold to attain greater compactness, assuring a durable firm connection and hence firm affixation on the hot runner manifold or on the hot runner nozzle. In either case the heating unit as a whole requires little space whereby, compared to other heating units and at nearly the same outputs, the hot runner nozzles may be kept exceedingly compact. Furthermore, the heating unit of the invention may be manufactured simply and economically and thus manufacturing costs may be lowered.

At least one electrically insulating cover layer is provided above the resistance wire constituting the heating conductor, covering and electrically insulating from the outside the heating conductor and the support. Advantageously this covering layer shall be the heating unit's outermost layer.

Preferably, at least one temperature sensor of which the electric resistance depends on temperature is used to detect the temperature in the flow duct. On account of the changing resistance, the temperature is continuously detectable and the measured values may be used to control the heating unit of the present invention. The design of the temperature sensor may be conventional or it may be in the form of an electrically conducting layer of which the electrical resistance is temperature dependent. The instantaneous temperature can be continuously monitored on account of the varying electrical resistance, said measurements allowing regulating the heating unit of the present invention. The layer serving as the temperature sensor preferably shall be a PTC (positive temperature coefficient) or an NTC (negative temperature coefficient) material. Alternatively, a thermocouple may be used as a temperature sensor with the same structure as an ohmmeter and the measurement site being near the nozzle tip.

The temperature sensor and the heating conductor advantageously are radially situated in a common plane whereby the space occupied by the heating unit of the present invention may be reduced additionally.

Preferably, the support is made of a sintered material such as a ceramic or a sintered metal. However, a metal, a metal alloy, a steel or a steel alloy also may be used. Using a ceramic is advantageous in that the heating conductor respectively the resistance wire can be directly mounted on the support. If a metal is used, for instance, a tool steel, a hard metal or the like, or also a steel, then an insulating layer will be inserted between the support and the heating conductor in order to electrically insulate from each other said resistance wire and said support. Such an insulating layer however can also be present on a ceramic support, illustratively to improve adhesion.

Both the cover layer and the insulating layer acting as the intermediate layer preferably are vitreous and/or a ceramic dielectric layer which, following at least one firing process, shall be pressure-prestressed relative to the support, so that, when said support is internally pressure loaded, radius-depending delamination forces occurring at different amplitudes will be compensated within the insulating layer. Preferably pressure-prestressing is generated so that, as a function of the support's elongation parameters and depending on the particular case, a specific mismatch between the linear expansion coefficient of the ceramic insulating layer TEC_{DE} respectively the linear thermal coefficient of expansion TEC_{DEA} of the cover layer and the corresponding value of the support TEC_{M} shall be predetermined, the differential expansion TEC_{DE}−TEC_{M} respectively TEC_{DEA}−TEC_{M} not exceeding a value of 5·10⁻⁶K⁻¹.

Furthermore, the insulating layer and/or the cover layer preferably shall exhibit the property of wetting the support surface during the particular firing. Under certain conditions, it will be advantageous that the material shall at least partly pass into the crystalline state.

The insulating layer and/or the cover layer may exhibit a vitreous or vitreous-crystalline structure containing at least one preformed glass that at a predeterminable temperature of firing shall wet the support's surface. The material structure moreover may contain at last one preformed glass which at a predeterminable firing temperature shall at least partly pass into the crystalline state.

Additionally respectively alternatively the material structure may contain at least one further glass that does not crystallize under firing conditions and/or at least one a priori crystalline compound, where, by optimizing the quantitative portions of the preformed vitreous and crystalline components of the material structure and taking into account their particular TEC increments under the conditions of the particular firing, a ceramic dielectric layer will be prepared having a TEC value in the range between 0 and 13·10⁻⁶ K⁻¹.

A compensation layer also may be configured between the support and the insulating layer and illustratively is made of chemical nickel. Such a compensating layer also serves to compensate the different expansion coefficients of the support and the insulating layers. This compensating layer may be deposited the same way as the insulating and cover layers.

Preferably, the insulating layer and/or the cover layer and/or the compensating layer shall be a fired foil or a fired thick film paste. The layers however also may be deposited by detonation coating and/or by thermal coating. Alternatively, dip-coating with ensuing firing may be used.

Appropriately, the resistance wire constitutes a heating conductor helix, where the design and/or the configuration is matched to the particular heat output needed. Consequently, the coils or turns of resistance wire to be mounted in a region requiring much heating will be illustratively very tightly configured with each other in order to apply more heat to that region. If moreover the resistance wire is helical or meandering, its pitch may be selected smaller or larger in segments to vary the heat energy output. Again, the resistance wire's cross-section may be varied as called for.

A contacting layer may be configured in each case between the insulating layer, the heating conductor and/or the temperature sensor. Again, as regards said contacting layer and/or the temperature sensor and/or the intermediate (insulating) layer configured between the support and the heating conductor, they are preferably selected fired foils or fired thick-film pastes. These may be deposited in simple and economic manner, in particular regarding structuring and handling, as a result of which an exceedingly reliable and advantageous heating unit may be manufactured.

Altogether, the insulating layer and/or the cover layer and/or the compensating layer and/or the contacting layer and/or the layer acting as the temperature sensor constitute the compound layer imbedding the resistance wire, as a result of which a compact design of the heating unit of the present invention shall be attained. This applies in particular when the resistance wire forming the heating conductor is imbedded into the insulating layer and/or in the contacting layer.

The present invention furthermore relates to a hot runner system, in particular a hot runner nozzle or a hot runner manifold fitted with an electric heating unit of the above described kind. The tubular or muff-like support in this design is deposited/slipped onto a material feed pipe, a bar, a manifold arm, a nozzle or the like.

Alternatively, the tubular or muff-like support per se is or constitutes a material feed pipe, a bar, a manifold arm, a nozzle or the like. This feature improves the heat transfer from the heating unit to the object being heated.

The present invention also relates to a hot runner nozzle comprising an electric heating unit of the present invention, the tubular or muff-like support being deposited at a fit subtending a predetermined play on a material feed pipe. In this instance too the support itself may constitute the material feed pipe, thereby advantageously affecting the heat transfer.

Lastly, the present invention relates to a method for manufacturing an electric heating unit of the present invention used for hot runner systems, in particular for hot runner nozzles and/or hot runner manifolds, the resistance wire constituting the heating conductor being deposited on the support and subsequently the cover layer being deposited by foil printing of screen printing. Depositing the resistance wire as well as the cover layer is easily controlled and in combination is surprisingly advantageous. The heating unit made in this manner operates accurately and always reliably; this feature advantageously affects altogether the temperature distribution and the service life of the heating unit elements.

Depending on support design, and before the heating conductor forming the resistance wire is wound in place, the insulating layer is deposited by foil or screen printing onto said support, the resistance wire being appropriately imbedded into the insulating layer.

The layers deposited by screen printing advantageous shall be in the form of pastes deposited by wraparound printing, assuring overall procedural economy. Each layer may be deposited separately and then be fired; the firing temperature may vary with each layer. However the firing temperature may be varied individually for each layer and lower it after each firing step. In another implementation of the method of the present invention, all layers are deposited separately and are fired simultaneously (co-fired). The firing temperature range is between 800 and 1,400° C.

Further features, details and advantages of the present invention are defined in the claims and discussed in the following description of illustrative embodiments in relation to the appended drawings.

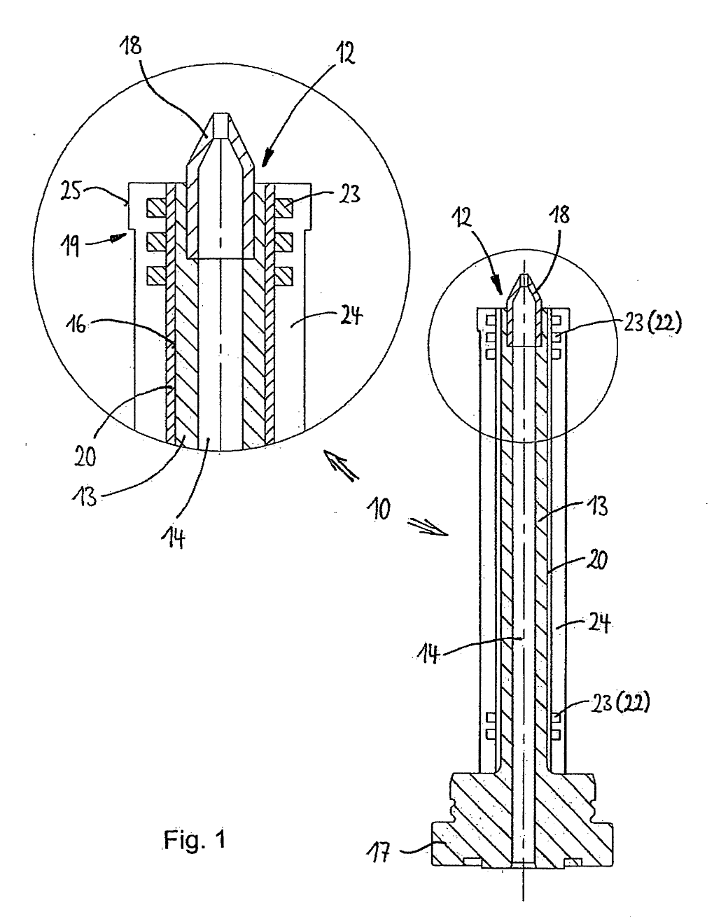

FIG. 1 is a schematic sectional view of a hot runner nozzle of the invention fitted with a first embodiment of a heating unit of the invention,

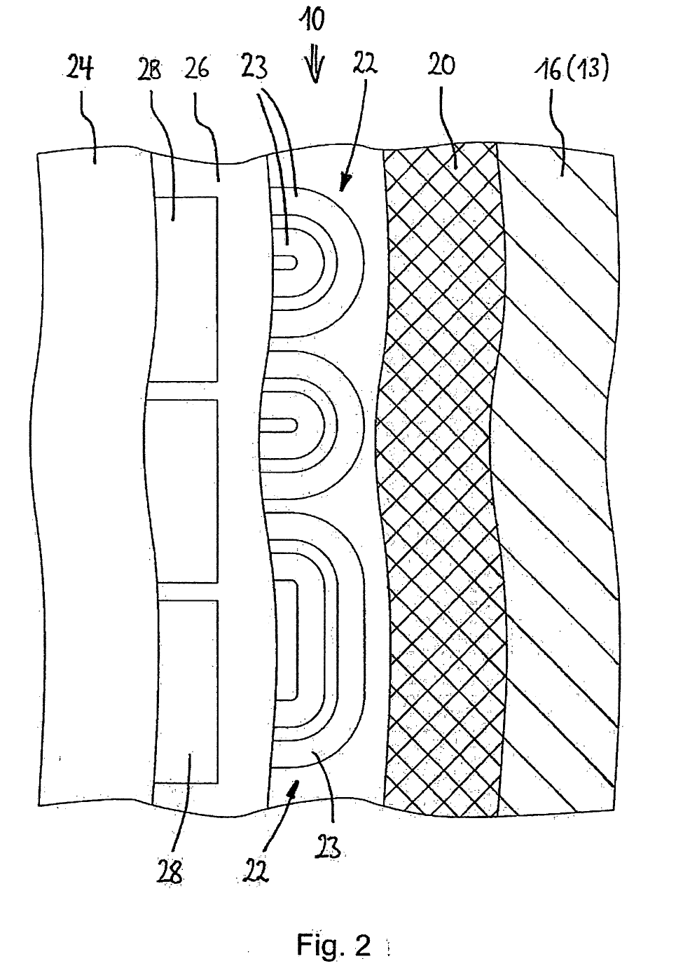

FIG. 2 shows the heating unit of FIG. 1 in a geometrically developed and partly fanned out representation,

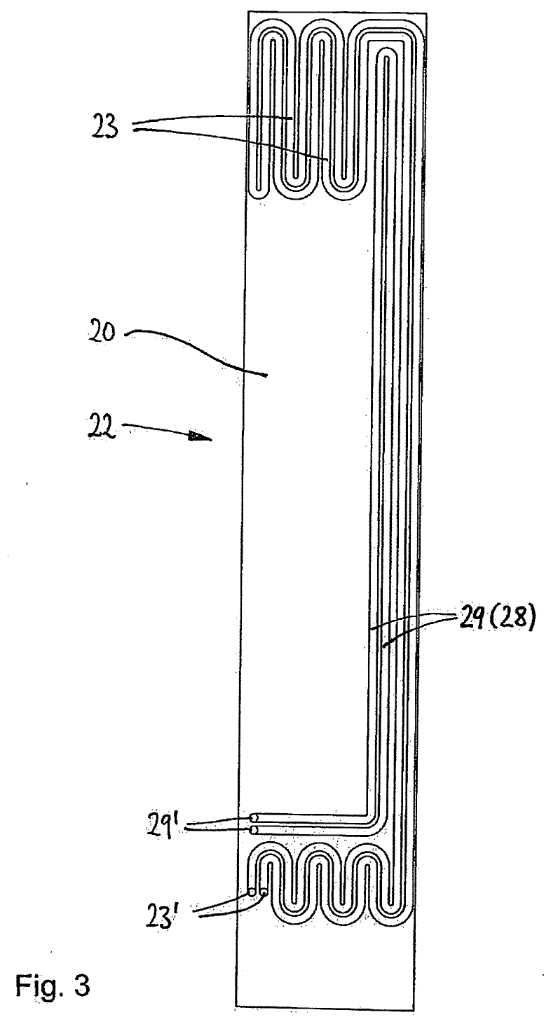

FIG. 3 shows the heating unit of FIGS. 1 and 2 fitted with a thermal sensor shown in geometrically developed form,

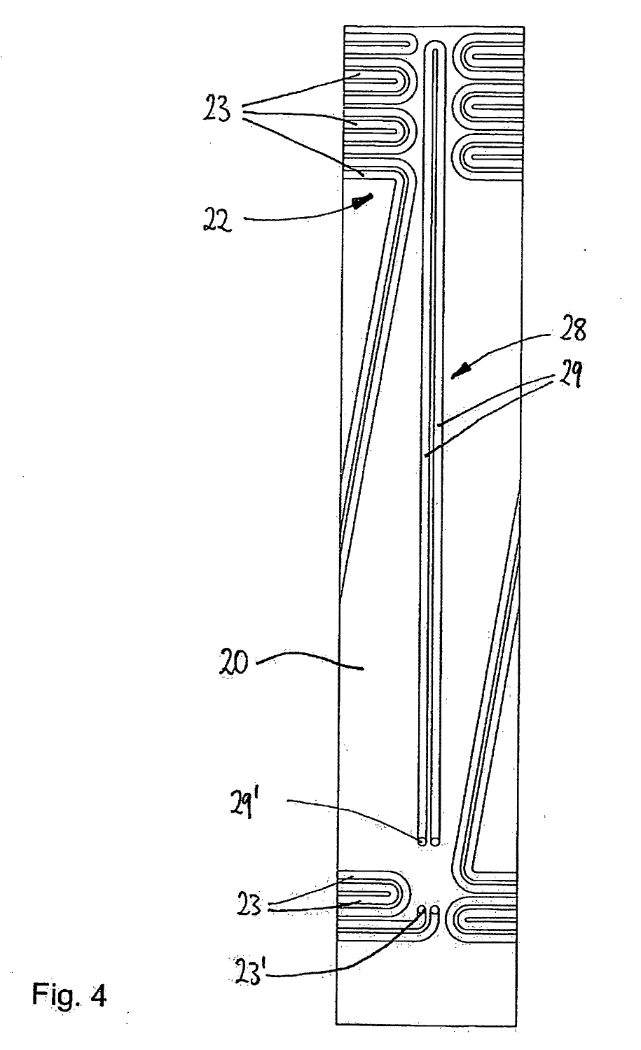

FIG. 4 shows another kind configuration of a heating unit and thermal sensor,

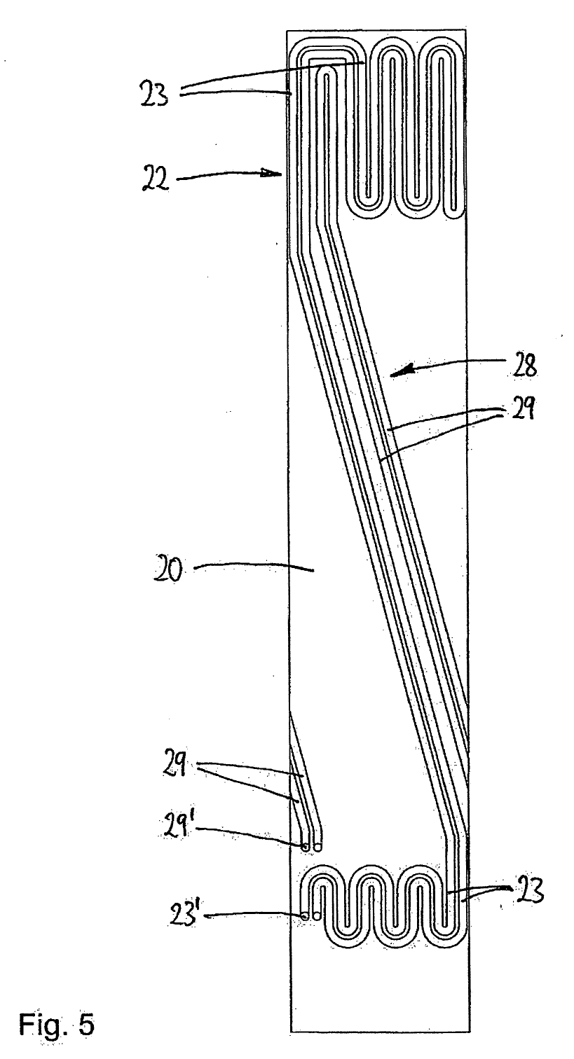

FIG. 5 shows still another embodiment mode of heating unit with a thermal sensor, and

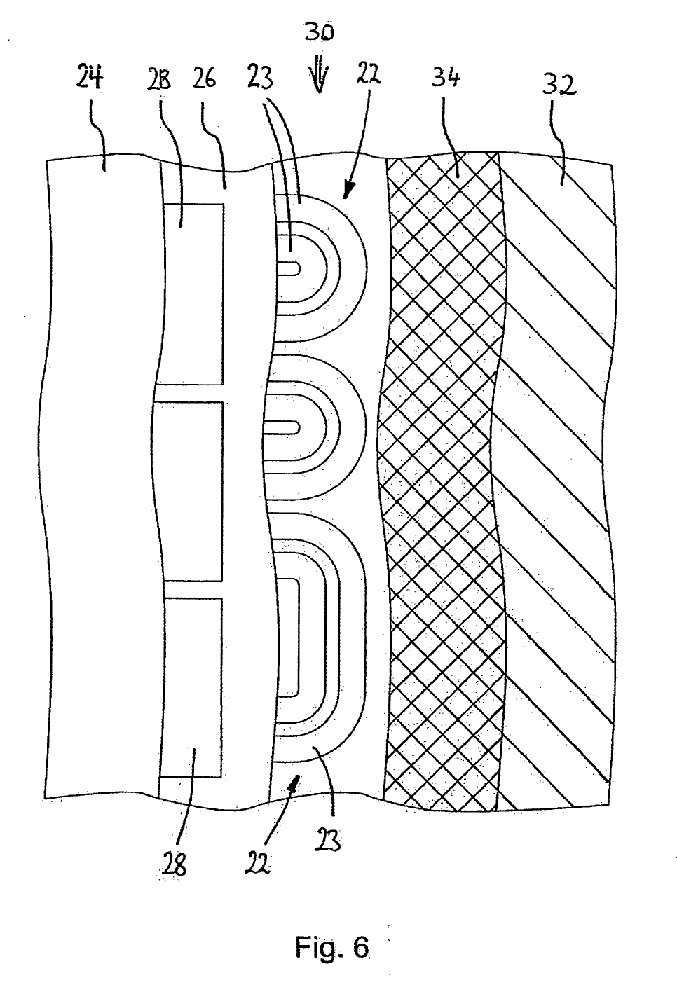

FIG. 6 shows an alternative embodiment of a heating unit of the invention in a geometrically developed and partly unfolded representation.

Below the same references denote similar components.

The hot runner nozzle 12 sketched in FIG. 1 is part of an injection molding equipment processing thermoplasts and shall be affixed to an omitted manifold and is fitted with an omitted housing receiving a cylindrical material feed pipe 13. A base 17 at the end of said pipe terminates flush with the housing and rests in sealing manner against a manifold. A nozzle tip 18 is inserted, preferably screwed into the end of the material feed pipe 13 running in the axial direction and extends the flow duct 14 subtended in the material feed pipe 13 as far as the omitted plane of an omitted mold nest. The nozzle tip 18 also may be integral with the material feed pipe 13, its operation remaining the same.

A heating unit 10 is mounted on the external surface of the wall 16 of the illustratively steel material feed pipe 13. Said heating unit comprises a casing-like ceramic support 20 serving simultaneous as an electric insulator, further a resistance wire 23 constituting a heating conductor helix 22 wound on said support, where, as schematically indicated in FIG. 2, said resistance wire also being laid out for instance in meandering manner depending on the desired temperature levels. An outer cover layer 24 is deposited above the resistance wire 23, covering the heating conductor 22 and the support below from the ambience and insulating them electrically. The resistance wire 23 may be laid out arbitrarily and may be mounted in varying thicknesses and/or configurations on the support 20 depending on the required power. This design allows attaining a defined temperature distribution within the material feed pipe 13.

In order to monitor and control/regulate both the rise and the time function of the temperature within the material feed pipe 13 respectively within the wall 16, a PCT temperature sensor 28 is configured between the support 20 and the cover layer 24, its resistance increasing with rising temperature (FIG. 2). An electrically insulating contacting layer 26 may be configured between the resistance wire 23 and the temperature sensor 28 to enhance thermal contact, said contacting layer if needed also being inserted between further layers.

Like the heating conductor helix 22, the temperature sensor 28 also may be made of a resistance wire 29 (FIGS. 3, 4). The resistance wire 29 constituting the temperature sensor 28 appropriately is situated in the same plane as the resistance wire 23 constituting the heating conductor helix 22. Both are protected jointly by the cover layer 24 from the ambience. The height of the heating unit 10 is minimized in this manner. FIGS. 3, 4, 5 show possible alternatives in structuring the heating conductor helix 22 and the conducting tracks 29 for temperature measurements.

Preferably the cover layer 24 and/or the contacting layer 26 are integrally deposited by direct coating on the support 20 and then are fired under the conditions required by the particular material, thereby producing an integral compound constituting the heating unit 10. Because the resistance wire 23 of the heating conductor helix 22 and the individual functional layers 24, 26 (possibly also 28) are unusually adhesive with respect to each other, the heating unit 10 per se withstands durably even extreme mechanical and/or thermal stresses.

The heating unit 10 is raised from below onto the material feed pipe 13 at a predetermined play selected in a way that said heating unit in its hot operational state shall not be damaged by the thermally expanded material feed pipe while nevertheless optimal heat transfer between the support 20 and the material feed pipe 13 is assured.

Improved heat transfer may be attained by additionally roughening the inside of the support respectively the outside of the material feed pipe.

Again, to improve the heat transfer, the inner side of the support element respectively the outer side of the material feed pipe may be fitted with a dark or black layer. This layer may be made of a black paint as used in radiation heating units. Alternatively or additionally, a dark substance may be used for the support, such as black aluminum oxide. If a metallic support is used, the firing process may induce dark tarnishing of the metal on the pipe inner side.

The foil printing and the thick-film screen printing techniques are suitable for the coating method of depositing the individual functional layers, further for the deposition of the insulating layer or the cover layer, where appropriate also for detonation coating or thermal coating procedures. Preferably, however the thick film screen printing technique shall be used while applying wraparound. Layer firing may be carried out individually or jointly.

The electric terminals 23′ and 29′ for the resistance wires 23, 29 of the heating conductor helix 22 and the temperature sensor 28 also may be made by the thick film technique or conventionally, the pertinent contacts being designed to allow feeding power respectively data transmission using plug-in cable connections.

FIG. 6 shows an alternative embodiment mode of a heating unit 30 of the present invention in a geometrically developed and partly fanned out representation. The heating unit 30 comprises a tubular or muff-like support 32 substantially corresponding to the support 20 of the heating unit 10 shown in FIGS. 1 and 2, but not made of a ceramic, instead of a metal or metal alloy. Electrical insulation is implemented by an insulating layer respectively a dielectric layer 34 deposited on the support 20, and the set of heating conductor helix 22 respectively contacting layer 26, temperature sensor 28 and cover layer 24 then being deposited on said layer 34, as in the case relating to heating unit 10 of FIG. 2. The individual functional layers are deposited in the same way as for the heating unit 10.

A first thick-film dielectric paste 34 is deposited on the surface of the support 32—where said surface was roughened beforehand in known manner to improve adhesion—to generate the dielectric layer by the wrap-around procedure. The solid part of said thick-film dielectric paste illustratively may be a glass crystallizing in-situ in a temperature range above 900° C. and having as its main components BaO, Al₂O₃ and SiO₂ of the approximate molar composition BaO Al₂ 4SiO₂. Subsequently to firing, the dielectric layer exhibits a TEC of 6·10⁻⁶K⁻¹ in the temperature range from 20 to 300° C.

Because the resultant TEC mismatch between the metal wall 16 and the dielectric layer 34 is of the order of magnitude of 5·10⁻⁶ K⁻¹, then it is to be expected when cooling the dielectric-coated wall 16 of the support 32 in the temperature range of purely elastic deformation, namely the glass transformation temperature between about 700° C. and room temperature, that there shall be a buildup of compressive stresses of about 3,500 bars (assuming a Young's modulus of 2·10⁶ bars for the dielectric 34). The magnitude of the pressure prestressing does not yet reach the critical boundary range of the intrinsic compressive strength of the dielectric starting at 6,000 bars. Said magnitude however is sufficient to reliably preclude tensile stresses in the dielectric layer 34 and hence also in the subsequent layers when the wall 16 of the support 32 is cyclically stretched at a load of 2,000 bars.

The present invention is not restricted to one of the above embodiments. Instead, it allows modifications and changes without thereby transcending the scope of protection defined by the appended claims.

All features and advantages, inclusive construction details, spatial configurations and procedural steps, explicit and implicit in the claims, specification and drawings, may be construed inventive per se and also in arbitrary combinations.

### LIST OF REFERENCES

10 heating unit
12 hot runner nozzle
13 material feed pipe
14 flow duct
16 wall
16 base zone
18 nozzle tip
20 support
22 heating conductor helix
23 resistance wire
23′ terminal
24 cover layer
26 contacting layer
28 temperature sensor
29 conducting tracks
29′ terminal
30 heating unit
32 support
34 dielectric layer

1. An electric heating unit (10, 30) for hot runner systems, in particular for hot runner nozzles (12) and/or hot runner manifolds, comprising a tubular of muff-like support (20; 32) which supports at least one heating conductor (22) constituted by a(n electric) resistance wire (23).

2. Heating unit as claimed in claim 1, characterized in that the resistance wire (23) constituting the heating conductor (22) is covered by at least one electrically insulating cover layer (24).

3. Heating unit as claimed in claim 1, characterized in that it is fitted with at least one temperature sensor (28).

4. Heating unit as claimed in claim 3, characterized in that the temperature sensor (28) is designed as an electrically conducting layer of which the electrical resistance is temperature dependent.

5. Heating unit as claimed in claim 3, characterized in that the layer (28) serving as a temperature sensor comprises a PTC or an NTC material.

6. Heating unit as claimed in claim 3, characterized in that the temperature sensor (28) is designed as a thermocouple and is made of a material suitable to generate a thermoelectric voltage.

7. Heating unit as claimed in claim 3, characterized in that the temperature sensor (28) and the resistance wire (23) constituting the heating conductor (22) are radially configured in a common plane.

8. Heating unit as claimed in claim 1, characterized in that the support (20; 32) is made of a sintered material.

9. Heating unit as claimed in claim 8, characterized in that the sintered material is a ceramic, a sintered metal or a sintered metal alloy.

10. Heating unit as claimed in claim 1, characterized in that the support (20; 32) is made of metal, a metal alloy, a steel or a steel alloy.

11. Heating unit as claimed in claim 1, characterized in that an insulating layer (34) is configured between the support (20; 32) and the resistance wire (23).

12. Heating unit as claimed in claim 1, characterized in that a compensating layer is configured between the support (20; 32) and the insulating layer (34).

13. Heating unit as claimed in claim 1, characterized in that the insulating layer (34) and/or the cover layer (24) and/or the compensating layer is a vitreous and/or ceramic dielectric layer.

14. Heating unit as claimed in claim 1, characterized in that the insulating layer (34) and/or the cover layer (24) and/or the compensating layer is compressively prestressed relative to the support (20; 32) after at least one firing procedure.

15. Heating unit as claimed in claim 14, characterized in that the linear thermal coefficient of expansion (TEC_{DE}) of the insulating layer (34) and/or the linear thermal coefficient of expansion (TEC_{DEA}) of the cover (24) and/or the linear thermal coefficient of expansion (TEC_{DEA}) of the compensation layer is less, following the firing procedure, than the linear thermal coefficient of expansion (TEC_{M}) of the support (20; 32).

16. Heating unit as claimed in claim 1, characterized in that the insulating layer (34) and/or the cover layer (24) and/or the compensating layer is a fired foil or a fired thick-film paste.

17. Heating unit as claimed in claim 1, characterized in that the insulating layer (34) and/or the cover layer (24) and/or the compensating layer is deposited by detonation coating or by thermal coating or by dip coating.

18. Heating unit as claimed in claim 1, characterized in that the resistance wire (23) constitutes a heating conductor helix.

19. Heating unit as claimed in claim 1, characterized in that the structure and/or the mounting of the resistance wire (23) is matched to particular need for heating power.

20. Heating unit as claimed in claim 1, characterized in that the resistance wire (23) is designed to meander at least segment-wise.

21. Heating unit as claimed in claim 1, characterized in that a contacting layer (26) is configured in each case between the insulating layer (34), the resistance wire (23) constituting the heating conductor (22) and/or the temperature sensor (28).

22. Heating unit as claimed in claim 1, characterized in that the contacting layer (26) and/or the layer (28) acting as the temperature sensor are fired foils or fired thick-film pastes.

23. Heating unit as claimed in claim 1, characterized in that the insulating layer (34) and/or the cover layer (24) and/or the compensating layer and/or the contacting layer (26) and/or the layer (28) acting as the temperature sensor constitute a layered compound imbedding the resistance wire (23).

24. Heating unit as claimed in claim 1, characterized in that the resistance wire (23) constituting the heating conductor (22) is imbedded into the insulating layer (34) and/or in the contacting layer (26).

25. A hot runner system, in particular a hot runner nozzle or a hot runner manifold fitted with an electric heating unit (10; 30) as claimed in claim 1.

26. Hot runner system as claimed in claim 25, characterized in that the tubular or muff-like support (20; 32) is mounted on a material feed pipe (13), a bar, a manifold arm, a nozzle or the like.

27. Hot runner system fitted with an electrical heating unit (10; 30) as claimed in claim 1, runner system comprising an electrical heating unit (10; 30), characterized in that the tubular or muff-like support (20,; 32) is or constitutes a material feed pipe (13), a bar, a manifold arm, a nozzle or the like.

28. Hot runner nozzle fitted with an electrical heating unit (10; 30) as claimed in claim 1, characterized in that the electrical heating unit (10; 30) is deposited on a cylindrical material feed pipe (13) while subtending a mechanical fit of a predetermined play.

29. Hot runner nozzle as claimed in claim 28, characterized in that the inner side of the support (20; 32) of the electrical heating unit (10; 30) and/or the outer side of the material feed pipe (13) is roughened slightly or fully.

30. Hot runner nozzle as claimed in claim 27, characterized in that the inner side of the support (20; 32) of the electrical heating unit (10; 30) and/or the outer side of the material feed pipe (13) is darkly coated or is tarnished darkly by heat treatment.

31. Hot runner nozzle fitted with an electrical heating unit (10; 30) as claimed in claim 1, characterized in that the tubular or muff-like support (20; 32) is or constitutes a material feed pipe (13).

32. A method for manufacturing an electrical heating unit (10; 30) for hot runner systems, in particular for hot runner nozzles (12) and/or for hot runner manifolds as claimed in claim 1, characterized in that the resistance wire (23) constituting the heating conductor (22) is deposited on the support (20; 32) and then the cover layer (24) is deposited using a foil printing or screen printing procedure.

33. Method as claimed in claim 31, characterized in that the insulating layer (34) shall be deposited by foil printing or screen printing on the support (20; 32) before the resistance wire (23) is deposited.

34. Method as claimed in claim 32, characterized in that the resistance wire (23) is imbedded into the insulating layer (34).

35. Method as claimed in claim 31, characterized in that the layers deposited by screen printing are deposited using the wraparound printing technique in the form of pastes.

36. Method as claimed in claim 34, characterized in that each layer is deposited separately and then is fired.

37. Method as claimed in claim 34, characterized in that the firing temperature varies with each layer.

38. Method as claimed in claim 36, characterized in that the firing temperature varies with each layer and is lowered after each firing step.

39. Method as claimed in claim 31, characterized in that all layers are deposited separately and are simultaneously fired (co-fired).

40. Method as claimed in claim 31, characterized in that the firing temperature range is between 800 and 1,400° C.
